(19) United States
(12) Patent Application Publication
(10) Pub. No.: US 2015/0201061 A1
(43) Pub. Date: Jul. 16, 2015

(54) AUTOMATICALLY PROVIDING PHONE NUMBERS VIEWED ON A DISPLAY SCREEN TO A DIALING INTERFACE OF A PHONE DEVICE

(71) Applicant: Cisco Technology, Inc., San Jose, CA (US)

(72) Inventors: John A. Toebes, Cary, NC (US); Mukul Jain, San Jose, CA (US)

(73) Assignee: Cisco Technology, Inc., San Jose, CA (US)

(21) Appl. No.: 14/153,307

(22) Filed: Jan. 13, 2014

(51) Int. Cl. H04M 1/725; H04M 3/02

(52) U.S. Cl. CPC H04M 1/72522; H04M 3/02; H04M 1/72583

(57) ABSTRACT

In one embodiment, a method includes a method includes obtaining dialing information from an application that is an active application on a computing system. The dialing information is displayed on a display screen of the computing system. A least one phone number is identified using the dialing information. The method also includes automatically providing the at least one phone number to a dialing interface of a phone device. The phone device is associated with the computing system.

### TECHNICAL FIELD

The disclosure relates generally to communication systems. More particularly, the disclosure relates to allowing phone numbers identified using information displayed on a screen of a computing device to be automatically provided to a dialing interface of a phone device.

### BACKGROUND

A personal computer or other computing device is often used by a user to perform activities such as sending e-mail, sending instant messages, and browsing the web. A user who has access to a personal computer often also has access to a phone, and the user may be known to be associated with both the personal computer and the phone.

A user may identify a phone number displayed on his or her personal computer, and wish to dial the phone number. By way of example, a user may identify a phone number in an e-mail message or on a web page, and decide to call the number. To call the phone number, the user generally manually enters the phone number into a dialing interface of his or her phone.

In some cases, a user may wish to call a person associated with an e-mail message or a web page, but a phone number of the person is not available in the e-mail message or on the web page. For example, a user may wish to call a person identified by an e-mail address in an e-mail message or by a full name on a web page. When a user obtains information relating to a person, the user may perform a manual look-up using the information to identify a phone number of the person. That is, a user may use information relating to a person to search for a phone number associated with the person. Once the phone number is identified, the user generally manually enters the phone number into his or her phone to call the phone number.

Click-to-call technologies allow a user to “click on” a phone number displayed on a display screen of a personal computer to cause a phone associated with the personal computer to obtain and to dial the phone number. The use of click-to-call technologies is effective, but essentially requires a user to take an action, i.e., to click on a phone number, in order to cause the phone number to be provided to an associated phone and dialed.

### BRIEF DESCRIPTION OF THE DRAWINGS

The disclosure will be readily understood by the following detailed description in conjunction with the accompanying drawings in which:

FIG. 1 is a block diagram representation of a system which includes a phone device and a computing device that includes a watcher arrangement in accordance with an embodiment.

FIG. 2 is a diagrammatic representation of a process of providing a phone number to a phone device that includes monitoring an active application window to identify dialing information in accordance with an embodiment.

FIG. 3 is a process flow diagram which illustrates a general method of operating a watcher in accordance with an embodiment.

FIGS. 4A and 4B are a process flow diagram which illustrates a method of operating a watcher with respect to an e-mail application in accordance with an embodiment.

FIG. 5 is a process flow diagram which illustrates a method of operating a phone device arranged to obtain at least one phone number from a watcher in accordance with an embodiment.

FIG. 6 is a diagrammatic representation of a process of providing at least one phone number associated with an e-mail to a phone device in accordance with an embodiment.

### DESCRIPTION OF EXAMPLE EMBODIMENTS

### General Overview

According to one aspect, a method includes obtaining dialing information from an application that is an active application on a computing system. The dialing information is displayed on a display screen of the computing system. A least one phone number is identified using the dialing information. The method also includes automatically providing the at least one phone number to a dialing interface of a phone device. The phone device is associated with the computing system.

### DESCRIPTION

The ability for a phone number that is displayed on a screen of a computer system to substantially automatically be provided to a dialing interface of a phone allows a user to efficiently call the phone number. By way of example, a phone number displayed in a window associated with an active application running on a computer screen may be automatically provided, substantially without any action by a user, to a dialing interface of an associated phone device. When the phone number is provided to the dialing interface, call to the phone number may readily be placed from the phone device by the user. By providing a phone number that is displayed on a display screen of a computer system substantially automatically to an associated phone device, the phone number may be dialed without a user having to manually enter the phone number into the phone device or having to take an action with respect to the computer system, e.g., without the user having to “click on” the phone number displayed on a display screen of the computer system.

In one embodiment, a phone number that is automatically provided to a dialing interface of a phone device may not be displayed on a screen of a computer system but, rather, information which allows the phone number to be identified may be displayed on the screen. When information which allows a phone number to be identified is displayed on a screen of a computer system, the information may be used to identify the phone number which may then be automatically provided to a dialing interface of the phone device. Such information, or dialing information, may include, but is not limited to including, a name, a user identifier (userid), or an e-mail address. A database or repository which associates phone numbers with names, userids, and/or e-mail addresses may be accessed to obtain a phone number that corresponds to the dialing information.

Generally, a watcher or a watcher arrangement which locates phone numbers or dialing information displayed on a display screen of a computing system is located on the computing system. The watcher may monitor applications on the computer system to identify an active application, or an application for which keyboard events would be directed by the computer system. It should be appreciated that an active application may also be considered to be an application that has a window which is active and, hence, displayed on a display screen of the computer system. The watcher may identify dialing information displayed by the active application, and cause a phone number to be automatically uploaded to or otherwise provided to a dialing interface of an associated phone device. In one embodiment, when the dialing information relates to multiple phone numbers, substantially all of the multiple phone numbers may be automatically provided to the dialing interface of the associated phone device. The multiple phone numbers may be provided in any suitable order, as for example a prioritized order in which priorities are based on at least one predetermined criterion.

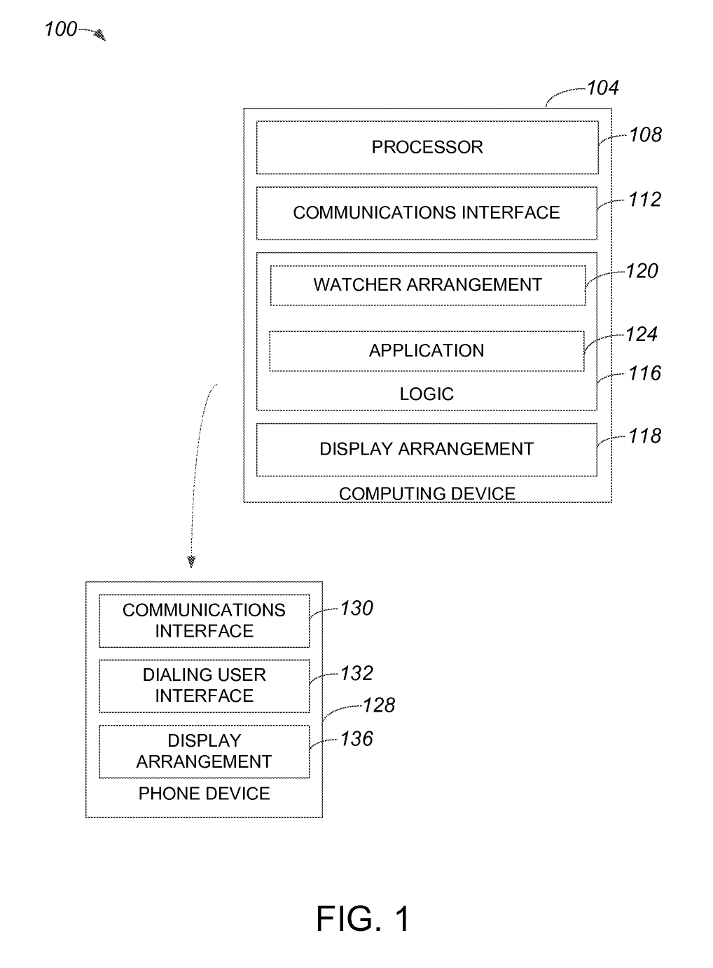

Referring initially to FIG. 1, a system which includes a phone device and a computing device that includes a watcher arrangement will be described in accordance with an embodiment. An overall system 100 includes a computing device 104 and a phone device 128. In one embodiment, computing device 104 is associated with phone device 128, e.g., computing device 104 and phone device 128 are both known to be associated with a particular user or party.

Computer device 104 includes a processor 108, a communications interface 112, logic 116, and a display arrangement 118. Processor 108 is configured to execute computer codes included in logic 116, which generally include hardware and/or software logic.

Communications interface 112 is arranged to allow computing device 108 to send and to receive data over a network, and to allow computing device 108 to exchange information with phone device 128. Communications interface 112 may include at least one input/output (I/O) port (not shown) that may be used to send and to receive data.

Logic 116 includes a watcher arrangement 120 and at least one application 124. Watcher arrangement 120 is arranged to monitor at least one application 124 associated with, e.g., resident on, computing device 104. Watcher arrangement 120 is configured to determine when an application 124 is active or opened, e.g., in use. An application 124 may be identified as active, in one embodiment, when a window associated with application 124 is active on computing device 104 and displayed on display arrangement 118. Application 124 may be any suitable application including, but not limited to including, an e-mail application, an instant messaging application, and/or a browser application.

When watcher arrangement 120 identifies application 124 as being active, watcher arrangement 120 may effectively analyze application 124 to identify any phone numbers displayed with respect to application 124, as for example on a display arrangement 118, and information which may allow phone numbers to be identified. That is, watcher arrangement 120 may analyze contents of an active window associated with application 124 to generally identify dialing information. Dialing information may include phone numbers and any other information which allows phone numbers to be identified.

Watcher arrangement 120 is further arranged to provide phone numbers identified with respect to an active window associated with application 124, to phone device 128. Phone numbers may be provided to phone device 136 substantially upon demand, and/or periodically. In one embodiment, phone numbers may be provided in a prioritized order, although it should be appreciated that phone numbers may be provided in any suitable order. Watcher arrangement 120 may be implemented through a number of different mechanisms of an operating system including, but not limited to including, Computer Based Training (CBT) hooks on a Windows operating system, Event notification hooks on the Windows operating system as SPY ++ works, and/or Event notification hooks on a standard MAC OS/X operating system as Objective C Hooks.

Phone device 128 includes a communications interface 130, a dialing user interface 132 and a display arrangement 136. In one embodiment, phone device 128 may be a Voice over Internet Protocol (VoIP) phone that is configured to communicate with computing device 104 over an Internet Protocol (IP) link (not shown). It should be appreciated that phone device 128 is no limited to being a VoIP phone and may be any suitable phone, e.g., a smart phone. Communications interface 130 allows phone device 128 to communicate with computing device 104. Dialing user interface 132 is configured to receive phone numbers from watcher arrangement 120, and to cause the received phone numbers to be displayed on display arrangement 136. Dialing user interface 132 is also configured to allow received phone numbers to be dialed.

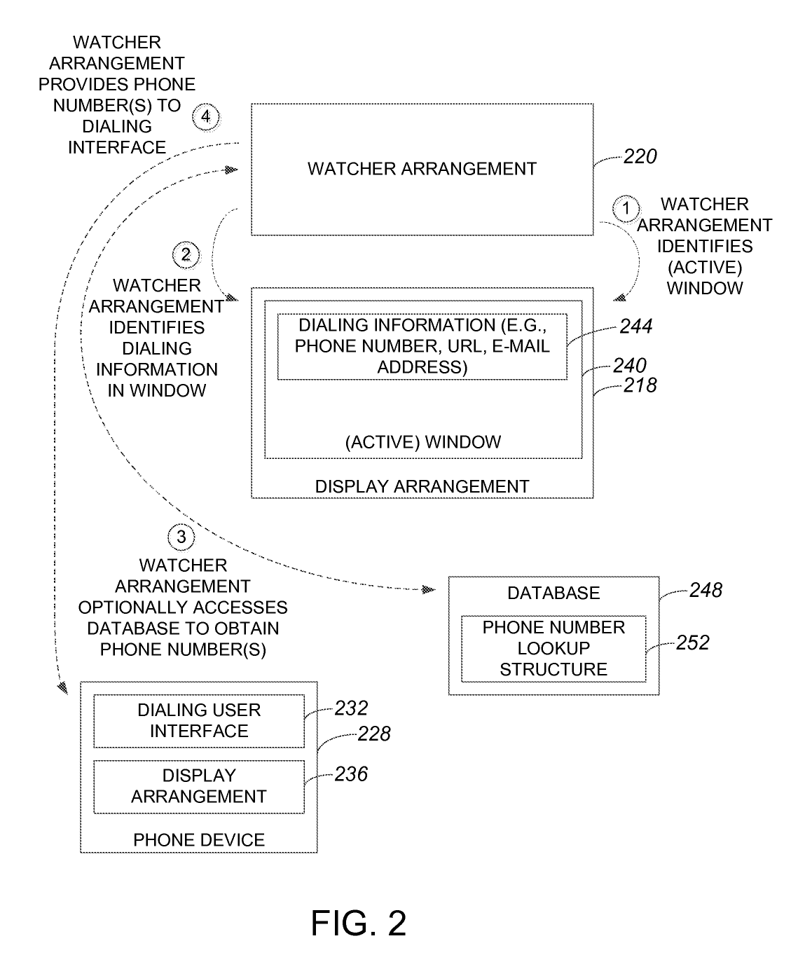

With reference to FIG. 2, a process of providing a phone number to a phone device that includes monitoring an active application window to identify dialing information will be described in accordance with an embodiment. At a time T1, a watcher arrangement 220 identifies an active window 240 on a display arrangement 218. At a time T2, the watcher arrangement identifies dialing information 244 in window 240. Dialing information is generally information which may be used to identify a phone number. By way of example, dialing information may include a phone number, a universal record locator (URL) link, a name of an individual or an entity, an e-mail address of an individual or an entity, a physical address of an individual or an entity, and/or a userid of an individual or an entity.

When the dialing information includes information other than a phone number, the watcher arrangement may use the dialing information to identify a phone number. As such, at a time T3, watcher arrangement 220 optionally accesses a phone number lookup structure 252 stored on a database 248 to identify or otherwise obtain a phone number. Phone number lookup structure 252 may generally cross-reference phone numbers to identifying information such as a URL link, a name, an e-mail address, a physical address, and/or a userid. Database 252 may include, but is not limited to including, a lightweight directory access protocol (LDAP), Google Search, a corporate direction, a personal address book, and/or any suitable local search index.

After watcher arrangement 220 obtains one or more phone numbers, directly from dialing information 244 and/or from phone number lookup structure 252, watcher arrangement 220 provides the one or more phone numbers to a dialing user interface 232 of a phone device 228 at a time T4 for display on a display arrangement 236 of phone device 228. It should be appreciated that the one or more phone numbers may be provided to dialing user interface 232 in a prioritized order, as for example an order based on a likelihood that a user may dial particular phone numbers. Time T4 may correspond to a time at which the one or more phone numbers are obtained by watcher arrangement 220, a time at which phone device 228 requests phone numbers from watcher arrangement 220, or a time at which watcher arrangement 220 is substantially scheduled to provide the one or more phone numbers.

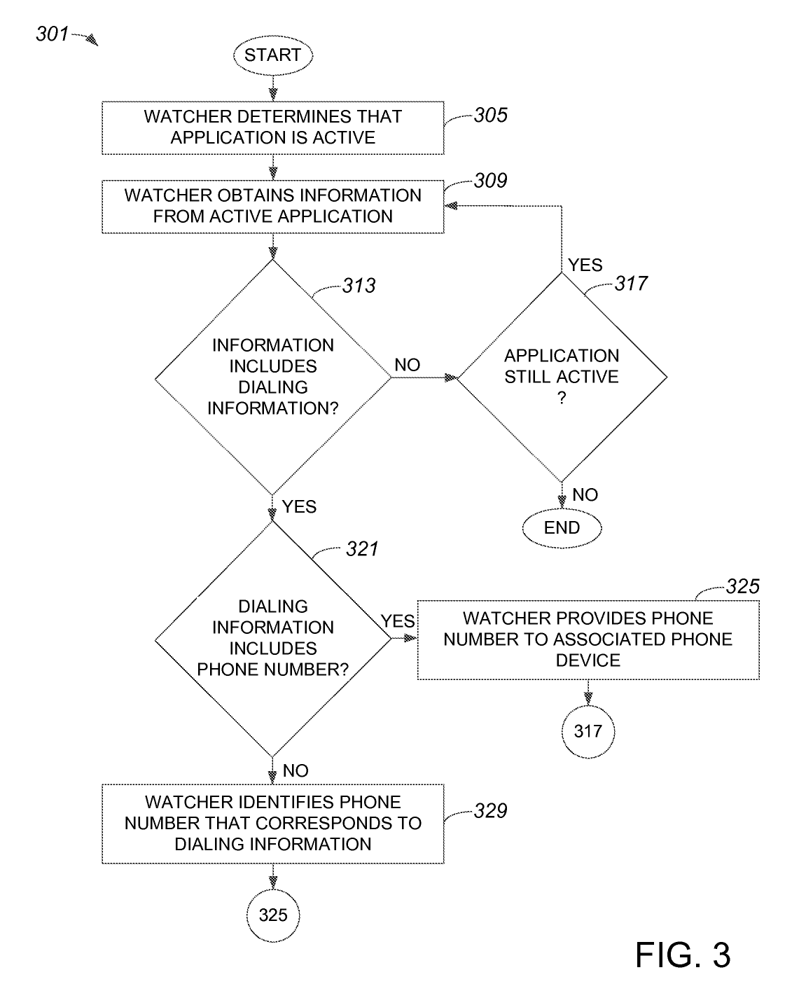

FIG. 3 is a process flow diagram which illustrates a general method of operating a watcher in accordance with an embodiment. A process 301 of operating a watcher begins at step 305 in which a watcher, e.g., a watcher arrangement of a computing system, determines that an application is active on the computing system. An application may generally be any suitable application, as for example an e-mail application, an instant messaging application, or a browser application. An application that is active is typically an open application, or an application that is in a state which allows a user to interact with the application and receives focus or events from a keyboard, a touch screen, a mouse, and/or any other input device. After the watcher determines that an application is active, the watcher obtains information from the active application in step 309.

A determination is made in step 313 as to whether the information obtained in step 309 includes dialing information. As previously mentioned, dialing information may be any information which allows a phone number to be identified. If the determination in step 313 is that the information does not include dialing information, process flow moves to step 317 in which it is determined whether the application is still active. If it is determined that the application is still active, then process flow returns to step 309 in which the watcher obtains information from the active application. On the other hand, if it is determined that the application is not still active, the process of operating a watcher is completed.

Returning to step 313, if it is determined that the information includes dialing information, then process flow moves to step 321 in which it is determined whether the dialing information includes a phone number. In the described embodiment, for ease of illustration, dialing information is information which either includes a single phone number or information which may be used to identify a phone number. It should be appreciated, however, that dialing information may generally include one or more phone numbers and/or information which may be used to identify one or more phone numbers. If the dialing information is determined to include a phone number, the watcher provides the phone number to an associated phone device, or a phone device known to be associated with the computer system, in step 325. After the watcher provides the phone number to the associated phone device, process flow returns to step 317 on which it is determined whether the application is still active.

Alternatively, if it is determined in step 321 that the dialing information does not include a phone number, the indication is that the dialing information includes information which may be used to identify a phone number. Accordingly, in step 329, the watcher identifies a phone number that corresponds to the dialing information. The watcher may access a data store or a database, for example, to locate a phone number that corresponds to the dialing information. Once a phone number is identified, process flow moves to step 325 in which the watcher provides the identified phone number to the associated phone device.

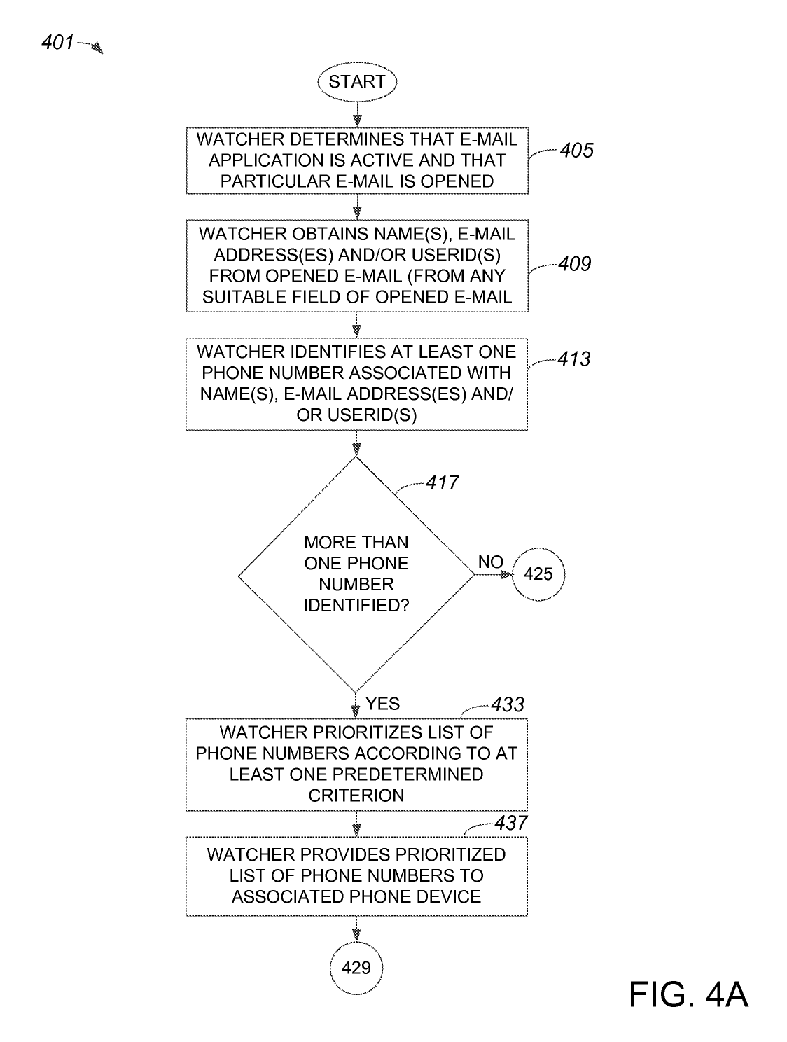

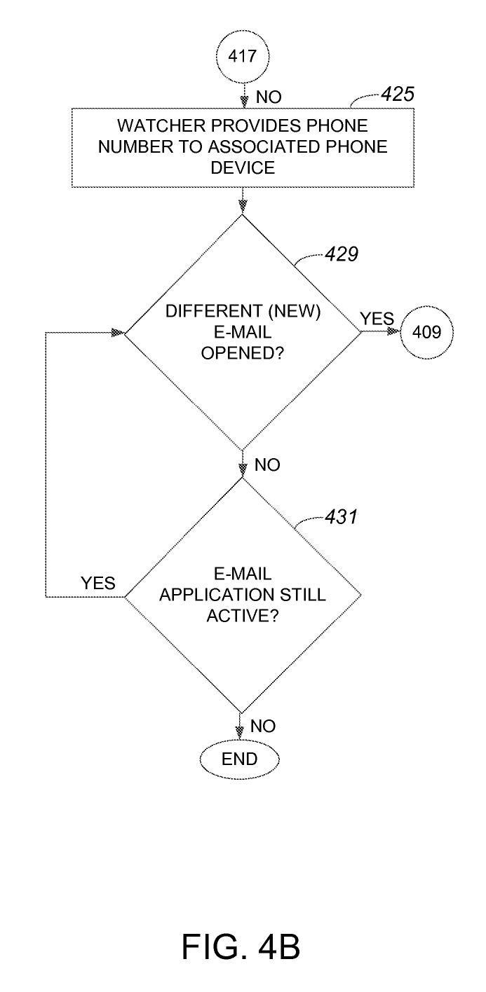

In one embodiment, an application that may be monitored by a watcher is an e-mail application. When an e-mail application is active, a watcher may monitor the e-mail application and identify dialing information in e-mails that are opened within the e-mail application. FIGS. 4A and 4B are a process flow diagram which illustrates a method of operating a watcher with respect to an e-mail application in accordance with an embodiment. A process 401 of operating a watcher begins at step 405 in which a watcher, e.g., watcher arrangement 120 of FIG. 1, determines that an e-mail application is active, and that an e-mail is opened in the e-mail application. An active e-mail application may be displayed in a window of a display screen, and an opened e-mail may be displayed in the window. It should be appreciated that the active e-mail application may generally be resident on a computer system.

Once the watcher determines that an e-mail application is active and that an e-mail is opened, the watcher obtains dialing information from the opened e-mail in step 409. The dialing information may generally be any information which is associated with a phone number, as for example a name, a userid, and/or an e-mail address identified in the opened e-mail. Dialing information may also include a phone number, as for example a phone number included in the body of the opened e-mail or a phone number included in a signature block, e.g., an electronic business card (vcard), associated with the e-mail. It should be appreciated that given information such as a name, a userid, and/or an e-mail address of a party, a phone number associated with the party may be identified. The dialing information may be obtained from a sender field, a recipient field, a subject field, and/or a body of an opened e-mail.

In step 413, the watcher identifies at least one phone number associated with a name, an e-mail address, and/or a userid included in the opened e-mail. Phone numbers may be identified using any suitable method including, but not limited to including, utilizing a lightweight directory access protocol (LDAP), searching a personal directory such as an address book associated with a user of the e-mail application, and/or searching a database associated with an enterprise, e.g., a corporate database.

A determination is made in step 417 as to whether more than one phone number has been identified. If it is determined that more than one phone number has not been identified, the indication is that a single phone number has been identified. As such, process flow moves from step 417 to step 425 in which the watcher provides the identified phone number to an associated phone device, e.g., a phone device that is associated with the e-mail application and/or a computer system on which the e-mail application is located. Any suitable process may be used to provide the identified phone number to the associated phone device. Suitable processes may include, but are not limited to including, a push process, a pull process, and/or a polled process.

After the watcher provides the phone number to the associated phone device, it is determined in step 429 whether a different, or new, e-mail has been opened in the active e-mail application. If the determination is that a different, or new, e-mail has been opened, then process flow returns to step 409 in which the watcher obtains at least one name, e-mail address, and/or userid from the different, or new, opened e-mail. Alternatively if the determination is that a different, or new, e-mail has not been opened, it is determined in step 431 whether the e-mail application is still active.

If it is determined in step 431 that the e-mail application is still active, then process flow returns to step 429 as to whether a different, or new, e-mail has been opened. Alternatively, if it is determined in step 431 that the e-mail application is not still active, then the process of operating a watcher is completed.

Returning to step 417, if the determination is that more than one phone number has been identified by the watcher, process flow moves from step 417 to step 433 in which the watcher prioritizes the phone numbers according to at least one predetermined criterion. That is, a list of phone numbers identified by the watcher is prioritized using any suitable criteria. Suitable criteria may include, but are not limited to including, a number of times each phone number has been called by a user of the active e-mail application and/or a location of a reference to a party associated with the phone number within the opened e-mail. By way of example, a phone number of a party that sent the opened e-mail may be prioritized higher than a phone number of a party that is identified in a recipient list for the opened e-mail. A list of phone numbers may also be prioritized based on social networking contacts associated with the user.

After the watcher prioritizes the list according to at least one predetermined criterion, the watcher provides the prioritized list of phone numbers an associated phone device in step 437. It should be appreciated that the watcher may provide the prioritized list of phone numbers using a push process, a pull process, and/or a polled process. Once the watcher provides the prioritized list of phone numbers to the associated phone device, process flow moves to step 429 in which it is determined whether a different, or new, e-mail has been opened.

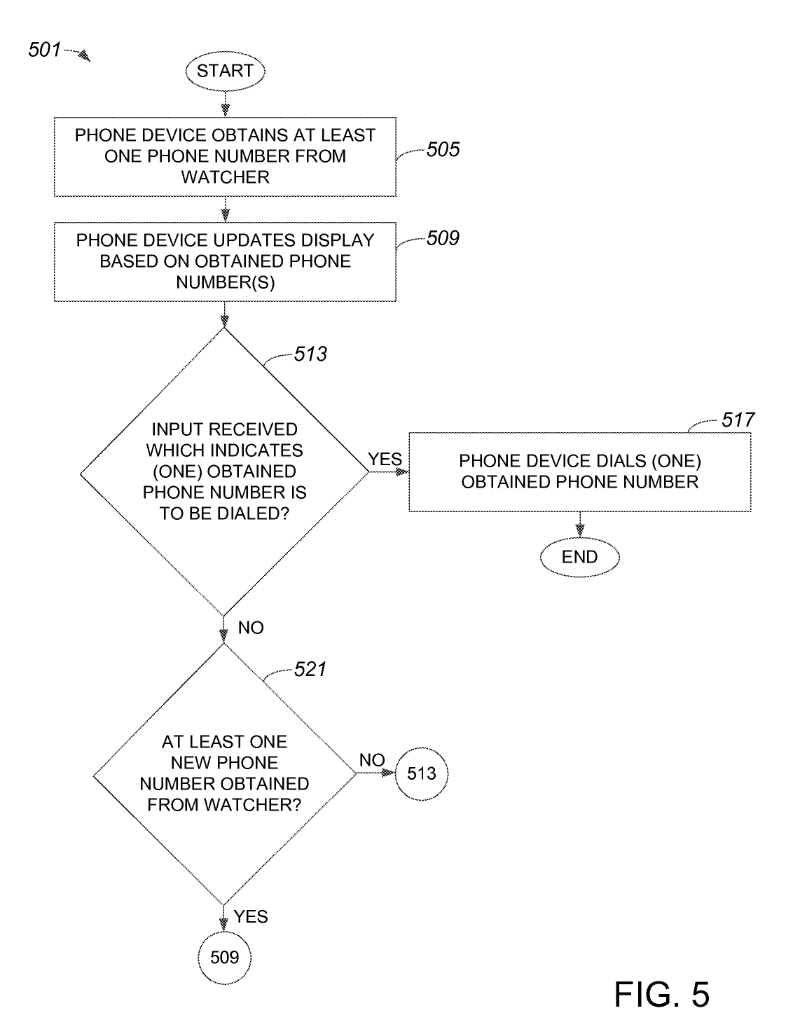

With reference to FIG. 5, a method of operating a phone device arranged to obtain at least one phone number from a watcher will be described in accordance with an embodiment. A process 501 of operating a phone device begins at step 505 in which the phone device obtains at least one phone number from a watcher, e.g., a watcher arrangement such as watcher arrangement 120 of FIG. 1. The phone number or phone numbers may be obtained in conjunction with an indication that the phone device is to update a list of phone numbers stored on the phone device. The phone device may generally obtain at least one phone number from a watcher in any suitable manner. A phone device may obtain, but is not limited to obtaining, any phone numbers from a watcher through a push process, a pull process, or a polled process. A push process generally involves a watcher pushing at least one phone number to the phone device when the watcher identifies at least one phone number in an active window. A pull process generally involves the phone device sensing that the phone device has been substantially activated, e.g., when a user interacts with the phone device, and effectively requesting that a watcher provide any phone numbers associated with an active application upon sensing that the phone device has been substantially activated. A polled process generally involves a watcher relatively periodically providing phone numbers associated with any active application to the phone device.

In step 509, the phone device updates its display based on any phone numbers obtained from a watcher. Updating a display may generally include, but is not limited to including, displaying the obtained phone numbers on a screen, setting soft buttons of the phone device to automatically dial the phone numbers when the soft buttons are activated, and/or populating physical buttons or keys on the phone device such that activating the physical buttons will dial the phone numbers. It should be appreciated that updating a display may include overwriting phone numbers previously obtained from a watcher, and that any suitable method may be used to determine which phone numbers are to be overwritten. By way of example, if the phone device has a user interface that may present six numbers in a display and the watcher presents three new numbers, the three oldest numbers may be replaced in the display.

A determination is made in step 513 as to whether the phone device has received an input which indicates that one of the obtained phone numbers is to be dialed. The input may be, in one embodiment, an input which activates a soft button that allows the phone number associated with the soft button to be dialed. If it is determined that one of the obtained phone numbers is to be dialed, then the phone device dials the obtained phone number in step 517, and the process of operating a phone device is completed.

Alternatively, if the determination in step 513 is that no input is obtained which indicates that an obtained phone number is to be dialed, process flow moves to step 521 in which it is determined if at least one new phone number is obtained from a watcher. If it is determined in step 521 that at least one new phone number has been obtained from the watcher, process flow returns to step 509 in which the phone device updates its display based on the newly obtained phone numbers. On the other hand, if it is determined in step 521 that at least one new phone number has not been obtained by the watcher, process flow returns to step 513 in which it is determined whether input which indicates that an obtained phone numbers is to be dialed has been obtained.

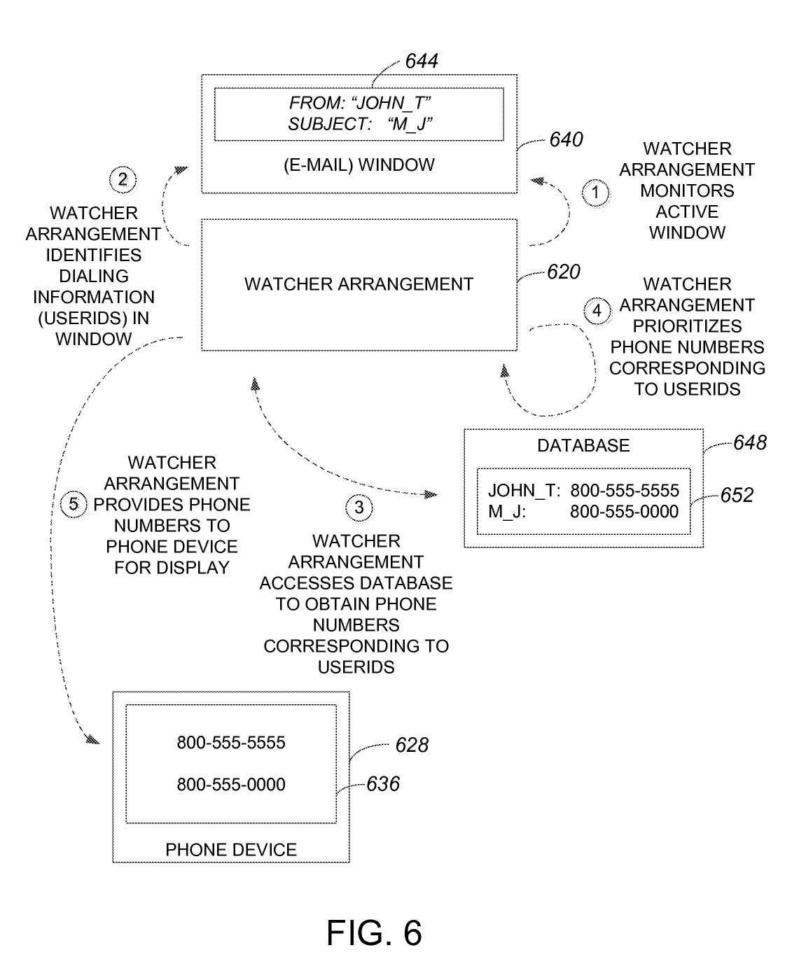

As discussed above with respect to FIG. 4, a watcher arrangement may be arranged to monitor or to otherwise watch an e-mail application when the e-mail application is active. In general, when an e-mail application is monitored, phone numbers corresponding to individuals associated with an email may be identified and provided to a phone device. FIG. 6 is a diagrammatic representation of a process of providing at least one phone number associated with an e-mail to a phone device in accordance with an embodiment. A watcher arrangement 620 is configured to monitor a window 640 associated with an e-mail application when the e-mail application is active. It should be appreciated that, in one embodiment, window 640 and watcher arrangement 620 are both located on a computing device (not shown).

At a time t1, the watcher arrangement 620 monitors window 640 because window 640 is active. At a time t2, watcher arrangement 620 identifies dialing information 644 in window 640. As shown, dialing information 644 includes userids, although it should be understood that dialing information 644 may generally include any information which may be used to identify an associated phone number. Dialing information 644 is generally obtained from an e-mail that is displayed in window 640, and may be obtained from substantially any section of the e-mail. By way of example, dialing information 644 may be obtained from a recipient field of an e-mail, a sender field of the e-mail, a subject field of the e-mail, and/or a body of the e-mail.

At a time t3, watcher arrangement 620 accesses a database 648. Database 648 may be installed on the same computing device (not shown) as watcher arrangement 620, or may be accessible to the watcher arrangement 620 through a communications interface. Watcher arrangement 620 accesses database 648 to obtain phone numbers corresponding to dialing information 644, e.g., userids. In one embodiment, database 648 may include a table 652 which associates userids to phone numbers. Watcher arrangement 620 may search table 652 using userids to identify phone numbers associated with the userids.

For ease of discussion, table 652 is shown as including one phone number for each userid. It should be appreciated, however, that each userid may be associated with more than one phone number. When more than one phone number is identified for a given userid, substantially all of the phone numbers associated with the given user may be returned to watcher arrangement 620. Alternatively, when more than one phone number is identified for a given userid, the phone number which is the preferred phone number associated with the given userid may be returned to watcher arrangement 620 while the other phone numbers may not be returned.

Once userids are effectively correlated to phone numbers and phone numbers are identified, watcher arrangement prioritizes the identified phone numbers at a time t4. Any suitable criterion may be used to prioritize the identified phone numbers, as mentioned above. For example, the identified phone numbers may be prioritized based on how often each phone number has been called, and/or where the userid associated with a particular phone number is in the e-mail displayed in window 640. In one embodiment, a phone number associated with a userid identified in a sender field of the email may be considered to be of a higher priority than other phone numbers associated with userids identified in the e-mail as it may be more likely that a sender of an e-mail is to be called using a phone device 628.

After a prioritized list of phone numbers is generated by watcher arrangement 620, watcher arrangement 620 provides the phone numbers to phone device 628 so that phone device 628 may cause the phone numbers to be displayed by phone device 628, e.g., in a display arrangement 636. Displaying the phone numbers may include, but is not limited to including, displaying the phone numbers on display arrangement 636 such that a user may effectively activate the displayed phone numbers to dial the displayed phone numbers, displaying the phone numbers in soft buttons (not shown) on display arrangement 636, and associating buttons (not shown) on phone device with the phone numbers.

Although only a few embodiments have been described in this disclosure, it should be understood that the disclosure may be embodied in many other specific forms without departing from the spirit or the scope of the present disclosure. By way of example, while a watcher that identifies an active application on a computer system has generally been described as running or executing on the computer system, a watcher is not limited to running or executing on the same computer system as the active application. A watcher may execute on a different computer system than the computer system the watcher is monitoring. For instance, a watcher may execute on a server and be arranged to monitor applications on a remote computing system.

While multiple phone numbers have been described as being automatically provided by a watcher to a phone device in a prioritized order or list, it should be appreciated that multiple phone numbers are not limited to being provided to a phone device in a prioritized order or list. That is, multiple phone numbers may be provided to a phone device in any suitable order. For example, multiple phone numbers may be ordered substantially randomly, or in an order that is substantially alphabetical with respect to the identities of owners of the multiple phone numbers.

Any suitable method may be used to associate a computing system to a phone device to enable a watcher to efficiently provide phone numbers identified with respect to an active application to the phone device. Suitable methods which effectively associate a phone device with a computing system may include, but are not limited to including, the computing system being made aware of the phone device via a network connection, utilizing registration information of the computing system and registration information of the phone device to identify the computing system and the phone device as being used by the same user, utilizing location information to determine that the computing system and the phone device are in substantially the same physical location, utilizing a discovery protocol to recognize a relationship between the computing system and the phone device, and/or manually providing an indication to a watcher that the computing system and the phone device are associated.

In one embodiment, a watcher may be located on a phone device, and may detect an active application on the phone device. That is, a watcher and an active application may be resident on a phone device, e.g., a smart phone. Such a watcher may obtain dialing information associated with the active application, and provide it to the phone device.

Dialing information has generally been described as including phone numbers and/or information which allows phone numbers to be identified. As mentioned above, dialing information may include, but is not limited to including, a URL link, a name, an e-mail address, a physical address, and/or a userid. It should be appreciated that dialing information may also include images and/or icons which may be associated with phone numbers. For example, a picture of an individual may be dialing information, as the picture may be used to identify the individual, and the individual may have an associated phone number.

In one embodiment, a watcher may monitor a current selection on a display screen to identify dialing information, and to provide an associated phone number to an associated phone. For instance, a phone number that is currently selected on a display screen, or in a copy buffer associated with the display screen, may be provided substantially directly to a phone that is known to be associated with the display screen.

A watcher may be arranged to filter information provided to a phone. By way of example, a watcher may use information relating to phone numbers which have previously been dialed on a phone to determine whether a particular phone number obtained from a display screen is to be provided to a dialing interface on the phone. In addition, a watcher may provide more than a phone number to a phone. For instance, a watcher may provide a phone number to a phone, as well as a name of a person associated with the phone number and/or information which identifies any calendared or scheduled events involving the person associated with the phone number.

A watcher is not limited to running on a computing system. In one embodiment, a watcher may run on an IP phone, and may provide dialing information displayed on the IP phone to another phone, e.g., a smart phone. In another embodiment, a watcher may run on a smart phone, and may provide dialing information displayed on the smart phone to another phone, e.g., another smart phone or an IP phone.

A computer system on which dialing information is displayed has generally been described as being associated with a phone device to which the displayed phone number is provided. A phone device that is associated with a computer system may be a phone device that is in the possession of, assigned to and/or owned by the user who possesses, is assigned to, and/or owns the computer system, as mentioned above. A phone device that is associated with a computer system is not limited, however, to being in the possession of, assigned to, and/or owned by a user who also possesses, is assigned to, and/or owns the computer system. For instance, a phone device that is in physical proximity to a computer system, or at substantially the same location as the computer system, may be considered to be associated with the computer system.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
obtaining dialing information from an application, the application being an active application on a computing system, wherein the dialing information is displayed on a display screen of the computing system.
identifying at least one phone number using the dialing information; and
automatically providing the at least one phone number to a dialing interface of a phone device, the phone device being associated with the computing system.

2. The method of claim 1 wherein automatically providing the at least one phone number to the dialing interface of the phone device includes automatically providing the at least one phone number to the dialing interface to enable the at least one phone number to be dialed using the phone device.

3. The method of claim 1 wherein identifying the at least one phone number using the dialing information includes accessing a database, the dialing information being associated with at least one phone number included in the database, wherein accessing the database includes obtaining the at least one phone number using the dialing information.

4. The method of claim 3 wherein the dialing information is at least one selected from a group including name, an e-mail address, a physical address, a user identifier (userid), and a universal record locator (URL) link.

5. The method of claim 1 wherein the at least one phone number includes a first phone number and a second phone number, the method further including:
prioritizing the first phone number and the second phone number in a prioritized list, wherein providing the at least one phone number to the dialing interface of the phone device includes providing the prioritized list to the dialing interface.

6. The method of claim 1 wherein the application is one selected from a group including an e-mail application, an instant messaging application, and a browser application.

7. The method of claim 1 wherein the dialing information includes that at least one phone number, wherein automatically providing the at least one phone number to the dialing interface of the phone device includes automatically providing the at least one phone number from the active application on the computing system to the dialing interface of the phone device.

8. A tangible, non-transitory computer-readable medium comprising computer program code, the computer program code, when executed, configured to:
obtain dialing information from an application, the application being an active application on a computing system, wherein the dialing information is displayed on a display screen of the computing system.
identify at least one phone number using the dialing information; and
automatically provide the at least one phone number to a dialing interface of a phone device, the phone device being associated with the computing system.

9. The tangible, non-transitory computer-readable medium comprising computer program code of claim 8 wherein the computer program code operable to automatically provide the at least one phone number to the dialing interface of the phone device is further operable to automatically provide the at least one phone number to the dialing interface to enable the at least one phone number to be dialed using the phone device.

10. The tangible, non-transitory computer-readable medium comprising computer program code of claim 8 wherein the computer program code operable to identify the at least one phone number using the dialing information is further operable to access a database, the dialing information being associated with at least one phone number included in the database, wherein the computer program code operable to access the database is further operable to obtain the at least one phone number using the dialing information.

11. The tangible, non-transitory computer-readable medium comprising computer program code of claim 10 wherein the dialing information is at least one selected from a group including name, an e-mail address, a physical address, a user identifier (userid), and a universal record locator (URL) link.

12. The tangible, non-transitory computer-readable medium comprising computer program code of claim 8 wherein the at least one phone number includes a first phone number and a second phone number, wherein the computer program code is further operable to:
prioritize the first phone number and the second phone number in a prioritized list, wherein the computer program code operable to provide the at least one phone number to the dialing interface of the phone device is further operable to provide the prioritized list to the dialing interface.

13. The tangible, non-transitory computer-readable medium comprising computer program code of claim 8 wherein the application is one selected from a group including an e-mail application, an instant messaging application, and a browser application.

14. The tangible, non-transitory computer-readable medium comprising computer program code of claim 8 wherein the dialing information includes that at least one phone number, and wherein the computer program code operable to automatically provide the at least one phone number to the dialing interface of the phone device is further operable to automatically provide the at least one phone number from the active application on the computing system to the dialing interface of the phone device.

15. An apparatus comprising;
a communications interface;
an application;
a watcher arrangement, the watcher arrangement including computer program code, the watcher arrangement being configured to determine when the application is active, wherein the watcher arrangement is arranged to identify at least one phone number associated with the application and to provide the at least one phone number to a dialing interface of a phone device associated with the apparatus using the communications interface when it is determined that the application is active; and
a processor, wherein the processor is configured to execute the computer program code and the application.

16. The apparatus of claim 15 further including:
a display arrangement, the display arrangement being arranged to display information associated with the application, wherein the watcher arrangement is arranged to identify the at least one phone number in the information.

17. The apparatus of claim 15 further including:
a display arrangement, the display arrangement being arranged to display information associated with the application, wherein the watcher arrangement is arranged to identify dialing information included in the information and to identify the at least one phone number using the dialing information.

18. The apparatus of claim 17 further including:
a database, wherein the watcher arrangement is arranged to identify the at least one phone number from the database using the dialing information.

19. The apparatus of claim 15 wherein the at least one phone number includes a plurality of phone numbers, and wherein the watcher arrangement is arranged to prioritize the plurality of phone numbers in a prioritized list and to provide the prioritized list to the dialing interface of the phone device.
